(19) United States
(12) Patent Application Publication
(10) Pub. No.: US 2014/0374102 A1
(43) Pub. Date: Dec. 25, 2014

(54) Enzyme Assisted Well Treatment

(71) Applicant: Energy & Enviromental Services Inc., Oklahoma City, OK (US)

(72) Inventor: Melvin B. Smith, Oklahoma City, OK (US)

(21) Appl. No.: 14/239,056

(22) PCT Filed: Oct. 24, 2012
(86) PCT No.: PCT/US12/61753

§ 371 Date: Feb. 14, 2014

(51) Int. Cl. E21B 43/26; C09K 8/80; E21B 36/00; E21B 43/267; E21B 41/00

(52) U.S. Cl. CPC E21B 43/26; E21B 43/267; E21B 41/00; E21B 36/00; C09K 8/80
USPC 166/303; 166/308.1; 166/302; 507/201

(57) ABSTRACT

A solid chemical delivery system for delivering chemicals to an underground formation. The solid chemical is formed by dehydrating a silicate to form anhydrous silicate. Well chemicals are then introduced to the silica and form a tablet or pelletized chemical. The pelletized solid chemical is then delivered to the underground formation through the well bore with a proppant and fracturing fluid. This allows the well treatment chemicals to be released over time.

### FIELD OF THE INVENTION

The present invention relates to hydraulic fracturing and delivery methods for well treatment chemicals.

### SUMMARY OF THE INVENTION

The invention is directed to a method for fracturing a formation accessible through a wellbore. The method comprises the steps of providing an anhydrous silicate matrix formed to carry a well treatment chemical within the matrix to form a solid chemical and pumping the solid chemical, a proppant, and a fracturing fluid into the wellbore. The solid chemical is positioned within a fracture created by the fracturing fluid and provides a metered release of the well treatment chemical therefrom.

In another embodiment the invention is directed to a well treatment device. The device comprises an anhydrous silica matrix and a well treatment chemical held within the silica matrix to form a solid chemical. The chemical is releasable from the silica matrix within a wellbore.

In another embodiment, the invention is directed to a device for delivering a well treatment chemical into a wellbore. The chemical is prepared by a process. The process comprises providing a silicate matrix, heating the silicate matrix to drive off moisture contained therein to form an anhydrous silicate, and mixing the anhydrous silicate with a well treatment chemical to absorb the well treatment chemical with the silicate matrix to form a solid chemical.

### BRIEF DESCRIPTION OF THE DRAWINGS

FIG. 1 is a diagrammatic representation of an injection well and material delivery system for delivery of the well treatment chemical created in the process of FIG. 2.

FIG. 2 is a flow chart demonstrating a process of creating the solid well treatment chemical of the present invention.

FIG. 3 is a diagrammatic representation of a solar cell heating element for use with the present invention.

### DETAILED DESCRIPTION OF THE DRAWINGS

A hydraulic fracture is formed by pumping the fracturing fluid into the wellbore at a rate sufficient to increase pressure downhole to exceed that of the fracture gradient of the rock. The rock cracks and the fracture fluid enter the rock, extending the crack. To keep this fracture open after the injection stops, a solid proppant, commonly sand, is added to the fluid. The propped fracture is permeable enough to allow the flow of formation fluids to the well. Formation fluids include gas, oil, salt water, fresh water and fluids introduced to the formation during completion of the well during fracturing.

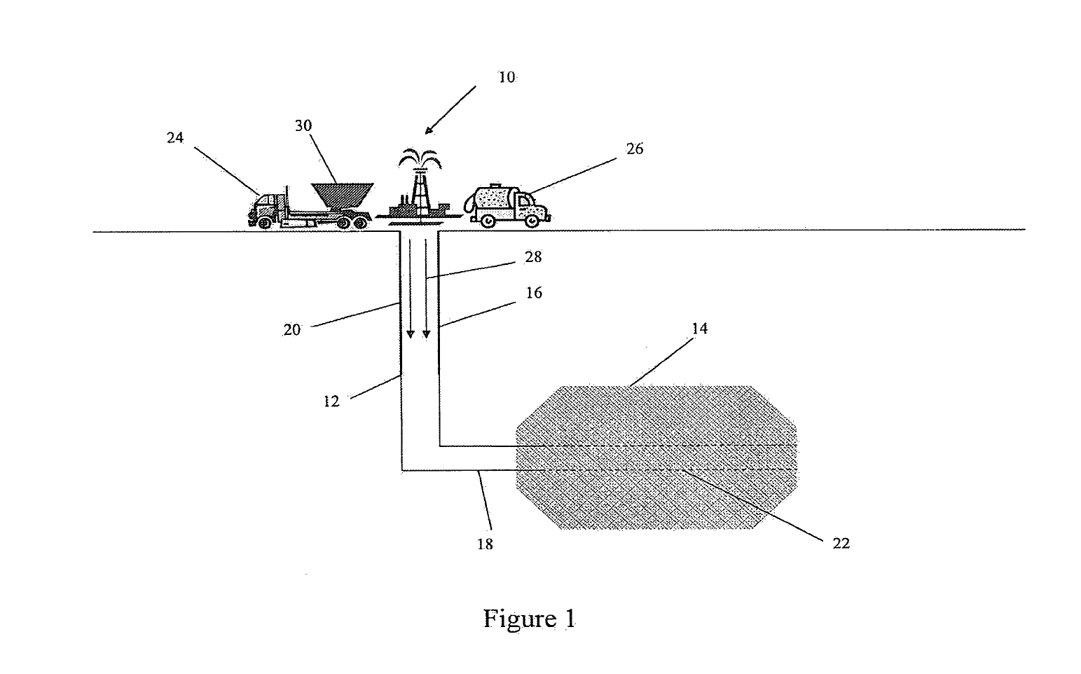

Turning to the figures in general and FIG. 1 specifically, shown therein is an injection well 10 for use with the claimed invention. The injection well comprises a well shaft 12 within a subterranean formation 14. The well shaft 12 comprises a vertical shaft 16 and may comprise a horizontal section 18. Further, the well shaft 12 comprises a well casing 20 that is adapted to seal a portion of the well shaft 12 such that fluids may not travel into or out of the subterranean formation 14 proximate the well casing. The well shaft 12 further comprises a production portion 22 that does not have a well casing 20 such that well treatment chemicals such as fracturing chemicals may be delivered to the subterranean formation 14 and desired products such as oil, natural gas, and natural gas liquids are removed from the subterranean formation.

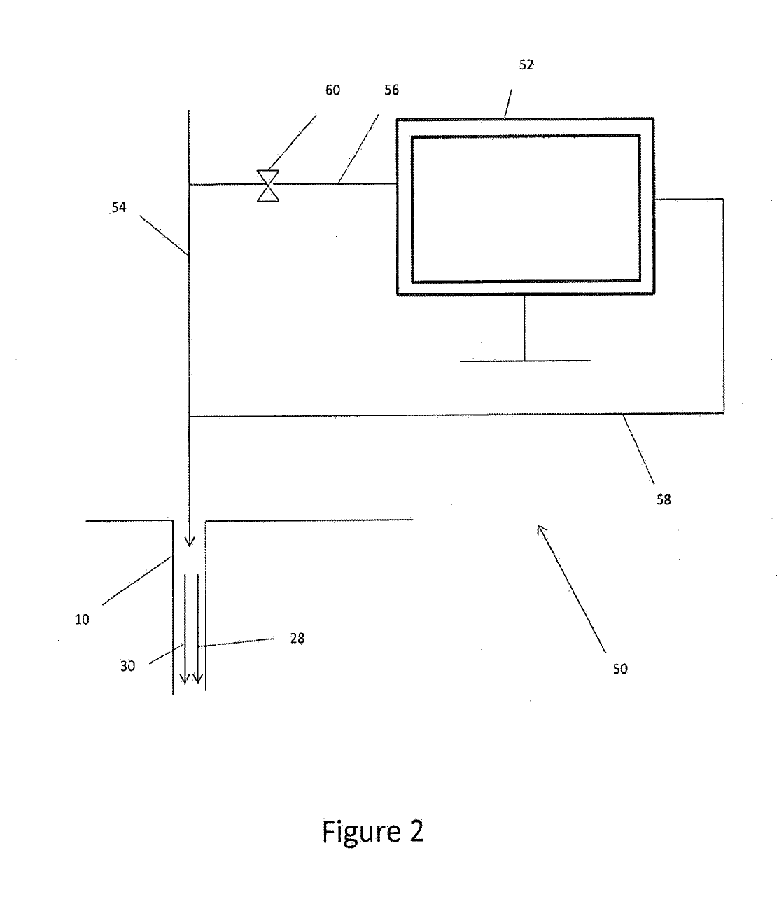

A material delivery system 24 is provided at ground level proximate the injection well 10. The material delivery system 24 delivers products into the well shaft 12 for enhancement of the drilling process. The material delivery system is preferably used in conjunction with a fracturing system 26 for delivery of ground level fracturing fluid 28 into the well shaft 12. The fracturing fluid 28, when delivered to the subterranean formation 14, causes hydraulic fracture and allows delivery of proppant and well treatment chemicals. The material delivery system 24 comprises a well treatment product 30 which is created through the process of FIG. 2.

With reference now to FIG. 2, the material delivery system 24 may comprise a heat treating system 50 for improving the treatment quality of the well treatment product 30. A solar panel 52 is provided to connect to a flow line 54 in communication with the injection well 10. Conventional solar panels 52 of many sizes may be utilized depending on the heat capacity needed for the particular heat treating system 50. The solar panel 52 is connected to the flow line 54 by an inlet pipe 56 and an outlet pipe 58. Well treatment product 30 and fracturing fluid 28 are fed into the injection well 10 from the flow line 54. Prior to entering the injection well 10, a portion of the fracturing fluid 28 is segregated into the inlet pipe 56, heated by the solar panel 52 and returned to the flow line 54 through the outlet pipe 58. One skilled in the art will appreciate that a valve 60 may be provided on the inlet pipe 56 to adjust the amount of fracturing fluid 28 and well treatment product 30 being heated. Therefore, the temperature of fracturing fluid 28 and well treatment product 30 entering the injection well 10 can be modulated or stabilized due to changes in environmental conditions and the heating capacity of the solar panel 52. Further, the heat treating system 50 may be mobile and the heat provided to the fracturing fluid 28 may depend upon the heaviness of oil located in the subterranean formation 14 (FIG. 1).

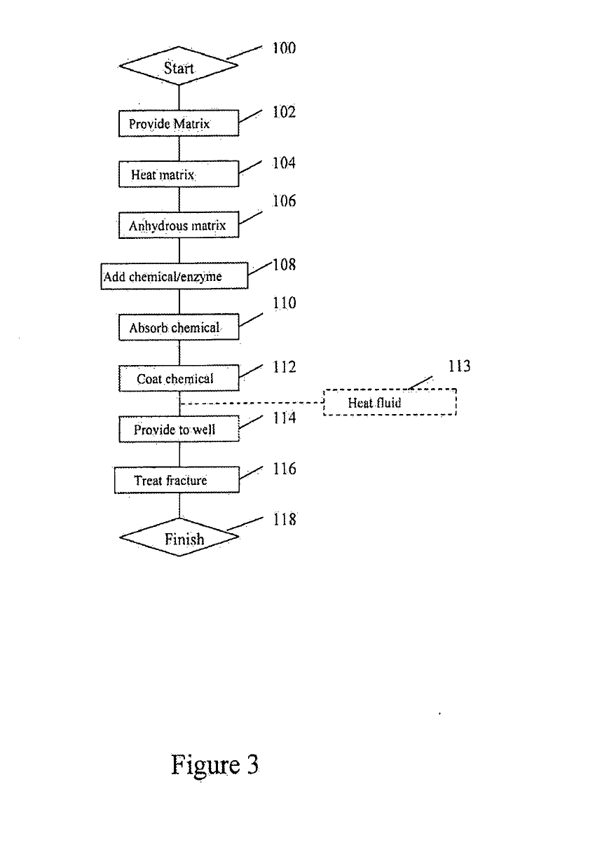

With reference now to FIG. 3, a method for creating an enhanced well treatment product 30 for delivery to the subterranean formation 22 by the material delivery system 24 (FIG. 1) is shown. As one skilled in the art will appreciate, liquid products have associated weaknesses, such as immediate delivery to a treatment location and an inability to control the delivery of chemical product over time. The method shown in FIG. 3 provides a process for creating a well treatment product 30 in a solid matrix form. The method starts at 100. A silicate matrix is provided at 102. The silicate matrix is heated at 104 to drive off moisture contained therein. When the moisture is removed, an anhydrous silicate is left at 106. The anhydrous silicate is mixed with a well treatment chemical and enzyme at 108 and the well treatment chemical is absorbed within the anhydrous silicate matrix at 110 to form a solid chemical. The solid chemical may then be coated with a resinous material at 112. The fracturing fluid 28 may be heated at 113. The heating of the fracturing fluid 28 may take place before or after the solid chemical is added to the fracturing fluid. The solid chemical, a proppant, and the fracturing fluid 28 are provided to the wellbore at 114. This causes the solid chemical to be positioned within the subterranean formation 14 and more particularly a fracture therein created by the fracturing fluid, providing a metered release of well treatment chemical at 116. The method ends at 118.

The solid chemical may comprise a silica spheroid, a silica pellet, or other shape. Preferably, the solid chemical silica matrix is a porous anhydrous silica spheroid. As used herein, “well treatment product” 30 comprises an advantageous chemical such as a scale inhibitor, corrosion inhibitor, paraffin product, H₂S scavenger, or foamer. Additionally, the product 30 could be an emulsifier, non-emulsifier, wetting agent, sludge preventive, retarder, suspension agent, anti-swelling agent, or stimulation additive.

Enzymes may be packaged with the solid chemical well treatment product 30 as a part of the solid chemical silica matrix created at step 102. Enzymes used for these purposes may comprise lipases, proteases and amylases. Enzymes, when used together in the solid chemical treatment matrix with the well treatment product 30, promote more efficient delivery of well treatment product to the subterranean formation 14. Heating the well treatment product 30 through providing heated fracturing fluid 28 alone or in conjunction with an enzyme may improve the ability of the well treatment product to enter the fracture of the subterranean formation 14.

One skilled in the art can envision other potential combinations of the principles disclosed in the above embodiments.

What is claimed is:

1. A method for delivering a liquid chemical agent in a solid form, the method comprising:
providing an anhydrous silicate matrix formed to carry a well treatment chemical within the matrix to form a solid chemical;
providing an enzyme proximate the silicate matrix; and
pumping the silicate matrix, a proppant, and a fracturing fluid into the wellbore;
wherein the solid chemical is positioned within a fracture created by the fracturing fluid and provides a metered release of the well treatment chemical therefrom.

2. The method of claim 1 wherein the anhydrous silicate comprises a silica spheroid.

3. The method of claim 1 wherein the anhydrous silicate comprises a silica pellet.

4. The method of claim 1 further comprising coating the solid chemical with a resinous material.

5. The method of claim 1 wherein the well treatment chemical comprises at least one of the following selected from: scale inhibitors, corrosion inhibitors, paraffin products, H₂S scavengers, or foamers.

6. The method of claim 1 wherein the enzyme comprises at least one of the following selected from: lipases, proteases and amylases.

7. The method of claim 1 wherein the silicate matrix comprises a porous anhydrous silica spheroid.

8. The method of claim 1 further comprising providing, a solar heat source.

9. The method of claim 8 further comprising:
diverting the fracturing fluid into the solar heat source;
heating the diverted fracturing fluid; and
providing the heated fracturing fluid to the wellbore upstream of the fracture.

10. A device for delivering a well treatment chemical into a wellbore prepared by a process comprising:
providing a silicate matrix;
heating the silicate matrix to drive off moisture contained therein to form an anhydrous silicate;
applying an enzyme to the anhydrous silicate; and
mixing the anhydrous silicate with a well treatment chemical to absorb the well treatment chemical with the silicate matrix to form a solid chemical.

11. The device of claim 10 wherein the anhydrous silicate comprises a silica spheroid.

12. The device of claim 10 wherein the anhydrous silicate comprises a silica pellet.

13. The device of claim 10 further comprising coating the solid chemical with a resinous material.

14. The device of claim 10 wherein the well treatment chemical comprises at least one of the following selected from: emulsifiers, inhibitors, non-emulsifiers, wetting agents, sludge preventives, retarders, suspension agents, anti-swelling agents, or stimulation additives.

15. The device of claim 10 wherein the silicate matrix comprises a porous anhydrous silica spheroid.

16. The device of claim 10 wherein the enzyme comprises at least one of the following selected from: lipases, proteases and amylases.

17. A method for preparing a well treatment chemical for downhole treatment of a wellbore comprising:
carrying a fracturing fluid to a solar heat source;
heating the fracturing fluid at the solar heat source;
providing a solid chemical into the fracturing fluid, wherein the solid chemical comprises an anhydrous silicate matrix and a well treatment chemical;
delivering the solid chemical and heated fracturing fluid to a fracture in the wellbore.

18. The method of claim 17 wherein the solid chemical is coated with a resinous material.

19. The method of claim 17 wherein the solid chemical is provided to the fracturing fluid prior to heating the fracturing fluid.

20. The method of claim 17 wherein the solid chemical is prepared by a process comprising:
providing a silicate matrix;
heating the silicate matrix to drive off moisture contained therein to form the anhydrous silicate matrix;
applying an enzyme to the anhydrous silicate matrix; and
mixing the anhydrous silicate matrix with the well treatment chemical to absorb the well treatment chemical with the silicate matrix to form a solid chemical.
